(19) United States
(12) Patent Application Publication
(10) Pub. No.: US 2025/0113961 A1
(43) Pub. Date: Apr. 10, 2025

(54) AUTOMATIC SWIMMING POOL CLEANER CHARGING SYSTEMS WITH IMPROVED CHARGING CONTACTS

(71) Applicant: ZODIAC POOL CARE EUROPE, Belberaud (FR)

(72) Inventors: Arnaud Lancry, Le Vernet (FR); Benjamin Fontanili, Belberaud (FR)

(73) Assignee: ZODIAC POOL CARE EUROPE, Belberaud (FR)

(21) Appl. No.: 18/909,181

(22) Filed: Oct. 8, 2024

Related U.S. Application Data
(60) Provisional application No. 63/543,394, filed on Oct. 10, 2023.

(51) Int. Cl. A47L 11/40; E04H 4/16

(52) U.S. Cl. CPC A47L 11/4002; E04H 4/1654; A47L 2201/022

(57) ABSTRACT

A charging system for an automatic swimming pool cleaner may a corrosion-mitigating device for an electrical contact. Additionally, or alternatively, a charging system for an automatic swimming pool cleaner may include a charging pin. In some embodiments, the charging system includes a charging pin that is externally removable from the automatic swimming pool cleaner or from a charging station for the automatic swimming pool cleaner.

### REFERENCE TO RELATED APPLICATION

The application claims the benefit of and priority to U.S. Provisional Patent Application No. 63/543,394, filed on Oct. 10, 2023, and entitled AUTOMATIC SWIMMING POOL CLEANER CHARGING SYSTEMS WITH IMPROVED CHARGING CONTACTS, the content of which is hereby incorporated by reference in its entirety.

### FIELD OF THE INVENTION

The invention relates to automatic swimming pool cleaners (APCs) for cleaning water-containing vessels such as swimming pools and spas and more particularly, although not necessarily exclusively, to charging systems and devices for APCs with charging contacts having corrosion mitigation features.

### BACKGROUND

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Some APCs include on-board power sources such as on-board batteries, and the on-board power sources may be charged and/or re-charged using a charging system such as a charging station, a charging dock, a charging trolley, etc. (collectively referred to herein as “charging stations”). Charging the battery of the APC commonly includes contacting electrical contacts of the APC with corresponding electrical contacts of the charging system, but traditional charging techniques may cause corrosion of the electrical contacts due to the presence of water from the swimming pools around the electrical contacts. For example, the water itself may cause corrosion, as well as contents of the water such as salt, free available chlorine, combined chlorine, acid fluids, basic fluids, substances of varying pH, substances of varying alkalinity, calcium hardness, cyanuric acid, dirt, and/or air. Such contents may exacerbate corrosive effects that can occur when electrical current passes through the electrical contacts, particularly if the electrical contacts are wet. Moreover, temperature, humidity, and other environmental factors can also exacerbate the electrical contacts' propensity to corrode when wet and/or exchanging current. Such corroded electrical contacts can compromise the charging efficiency of an APC, can pose an electrical shock hazard, can compromise the ability of a battery within the APC to hold a charge, and can harm the life of the battery, the trolley, or the APC.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a charging system for an APC includes a corrosion-mitigating device for an electrical contact.

According to various embodiments, a charging system for an APC, the charging system comprising a charging pin that is externally removable from the APC or from a charging station for the APC.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates charging system of a pool cleaner according to embodiments.

FIG. 2 illustrates a portion of the charging system of FIG. 1 according to embodiments.

FIG. 3 illustrates a portion of the charging system of FIG. 1 according to embodiments.

FIG. 4 illustrates a portion of the charging system of FIG. 1 according to embodiments.

FIG. 5 illustrates a portion of the charging system of FIG. 1 according to embodiments.

### DESCRIPTION OF THE INVENTION

Described herein are charging systems and devices for one or more batteries of APCs with charging contacts having one or more corrosion-mitigating devices for an electrical contact. The corrosion-mitigating devices may be on the APC, on a charging station, or on both the APC and the charging station. In some embodiments, the corrosion-mitigating device may include a drying device for drying and/or removing water from the electrical contact prior to charging of the batteries. In various embodiments, the corrosion-mitigating device may include a coupling system for removably coupling the electrical contact to the APC and/or charging system and such that the electrical contact is externally removable. In such embodiments, the corrosion-mitigating device may allow for easy removal and/or replacement of electrical contacts in the event of strong corrosion and/or malfunctioning while improving modularity of the APC and/or charging system. In certain embodiments, the corrosion-mitigating device may include a cover with a fixed surface contact for charging the electrical contact via contact while covering the electrical contact. While the systems and devices provided herein are discussed in the context of electrical charging of APCs, the corrosion-mitigating devices may be provided on any contacts or surfaces for any charging and/or electrical contact that may be exposed to water. Various other benefits and advantages may be realized with the systems, devices, and methods provided herein, and the aforementioned advantages should not be considered limiting.

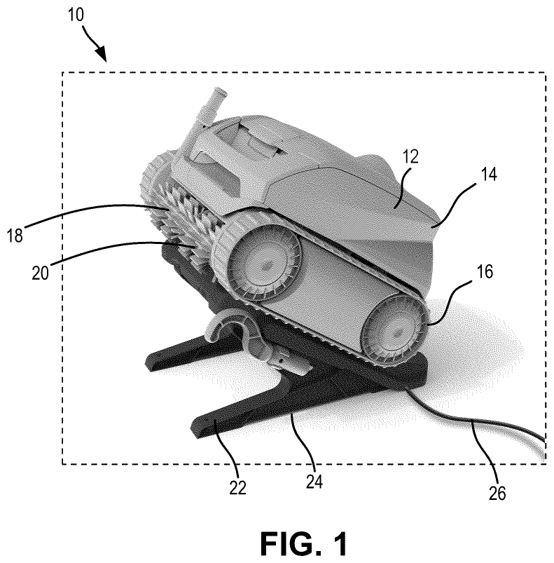

FIG. 1 illustrates an example of a charging system 10 for an APC 12 according to embodiments.

The APC 12 may be self-propelled and generally includes a body 14, one or more motive elements 16, and one or more cleaning devices 18 (including but not limited to a scrubber brush 20). A motor, pump, filter, and various other features may be provided on or within the APC 12 as desired. Non-limiting examples of APCs 12 may include those described in U.S. Pat. Nos. 10,316,534, 9,488,154, 8,578,538, and U.S. Patent Publication No. 2014/0303810, all of which are hereby incorporated by reference in their entireties.

In certain embodiments, the APC 12 includes an on-board power source, such as but not limited to one or more on-board batteries. In such embodiments, the APC 12 may include one or more electrical contacts (e.g., charging pads, pins, clips, terminals, plates, etc.). The electrical contacts may be provided on the one or more batteries of the APC and/or at various other locations on the APC 12 as desired.

The charging system 10 includes a charging station 22 with one or more complementary electrical contacts for selectively engaging the electrical contacts of the APC 12. Contact between the electrical contacts of the charging station 22 and the electrical contacts of the APC 12 enables charging and/or re-charging of the one or more batteries of the APC 12. The charging station 22 may be various devices or structures as desired. In FIG. 1, the charging system 10 is illustrated as a charging dock 24; however, in other embodiments, the charging system 10 may be other devices or structures such as but not limited to charging docks with other shapes and/or geometries, other charging stations, charging trolleys, garages, charging cords or cabling, and/or other structures or devices as desired. In some embodiments, the charging station 22 may support the APC 12 (e.g., a charging dock), although it need not in other embodiments (e.g., a charging cord or cabling). The charging system 10 may include a power source and/or may be electrically coupled to a power source (e.g., via electrical cabling 26) to selectively provide electrical power to the one or more batteries of the APC 12.

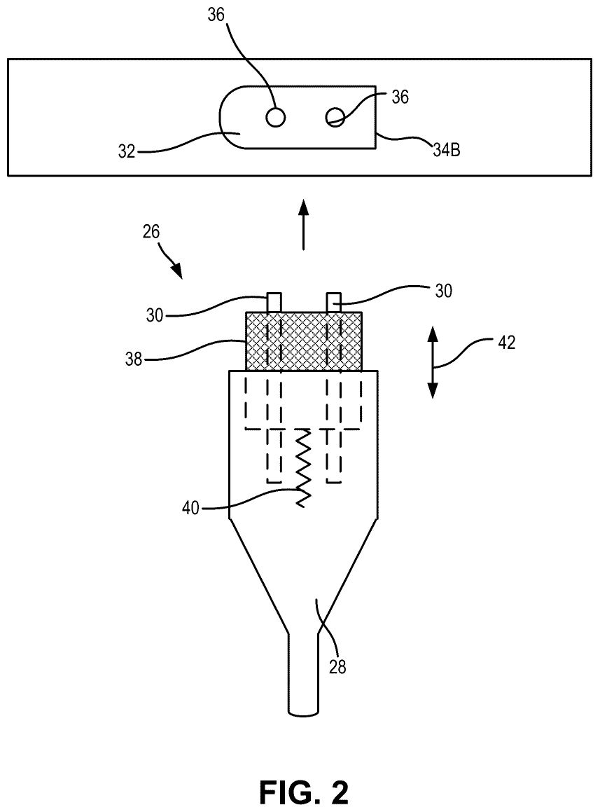

Referring to FIGS. 2-5, in various embodiments, the charging system 10 includes one or more corrosion-mitigating devices 26 for minimizing, reducing, and/or preventing corrosion of the electrical contacts due to the presence of water from a swimming pool or spa in which the APC 12 was operating. The corrosion-mitigating devices 26 may be provided on the charging station 22, the APC 12, or both the charging station 22 and the APC 12.

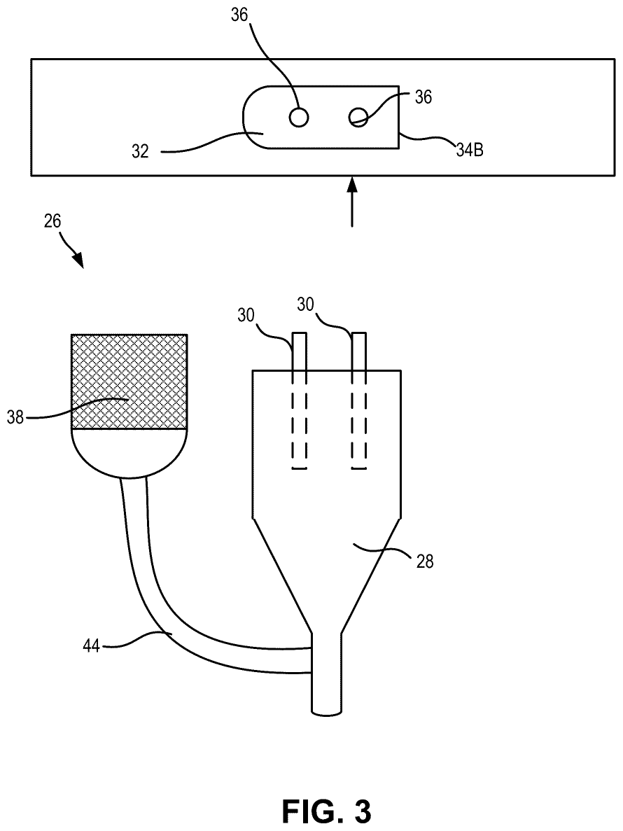

FIGS. 2 and 3 illustrate a charging plug 28 with one or more charging pins 30 as a first electrical contact 34A and a charging receiver 32 with one or more apertures 36 for the charging pins 30 as a second electrical contact 34B. In the embodiment illustrated, the charging plug 28 is a component of the charging station 10 (e.g., a charging cord or cabling) and the charging receiver 32 is on the APC 12, on the battery of the APC 12, and/or otherwise connected to the battery for the APC 12. However, in other embodiments, the charging plug 28 may be on the APC 12 and/or connected to the battery and the charging receiver 32 may be on the charging station 10.

Referring to FIGS. 2 and 3, in certain embodiments, the corrosion-mitigating device 26 may be a drying buffer or device 38 for drying and/or removing water from the electrical contacts 34A-B prior to charging of the battery using the electrical contacts 34A-B. The drying device 38 may be constructed from various materials suitable for drying and/or removing water as desired. As non-limiting examples, the drying device 38 may be a hydrophobic material, a fabric material, combinations thereof, and/or other materials as desired.

In some embodiments, and as illustrated in FIG. 2, a portion of the electrical contact 34A (e.g., the charging pins 30) may extend through the drying device 38. Optionally, the charging pins 30 are movable relative to the drying device 38 between a stowed position and a deployed position. In other embodiments, and as illustrated in FIG. 2, the drying device 38 may be movable relative to the electrical contact 34A. In such embodiments, the drying device 38 may be movable between a stowed position and a deployed position relative to the charging pins 30 (represented by arrow 42). Various mechanisms or devices may be provided enabling movement of the charging pins 30 relative to the drying device 38 and/or movement of the drying device 38 relative to the electrical contact 34A, such as various devices or mechanisms enabling a sliding or linear movement, rotational movement, pivoting movement, combinations thereof, etc. Optionally, a biasing mechanism 40 may bias the drying device 38 towards the stowed position or the deployed position. In FIG. 2, the biasing mechanism 40 biases the drying device 38 towards the deployed position. The biasing mechanism 40 may be various types of biasing mechanisms as desired and/or suitable for biasing the drying device 38. In FIG. 2, the biasing mechanism 40 is a spring.

In certain embodiments, the electrical contact 34A with the movable drying device 38 allows for a one-step plugging process while also minimizing or reducing corrosion by drying the electrical contacts 34A-B. As a non-limiting example, the charging pins 30 may be aligned with and inserted into the apertures 36 of the charging receiver 32, thereby causing automatic retraction of the drying device 38 to the stowed position and into the charging plug 28.

In other embodiments, and as illustrated in FIG. 3, the electrical contacts need not extend through the drying device 38. In such embodiments, the drying device 38 may be removably attached or fixed to either of the electrical contacts 34A-B. In FIG. 3, the drying device 38 is attached to charging plug 28 via a connecting member 44.

The drying device 38 of FIG. 3 may allow for a three-step plugging process while also minimizing or reducing corrosion by drying the electrical contacts 34A-B. As a non-limiting example, the drying device 38 may be moved into contact with the electrical contact 34A and/or the electrical contact 34B to dry and/or remove water from the electrical contacts 34A-B. After drying, the drying device 38 may be removed, and the charging pins 30 may be inserted into the apertures 36 of the charging receiver 32.

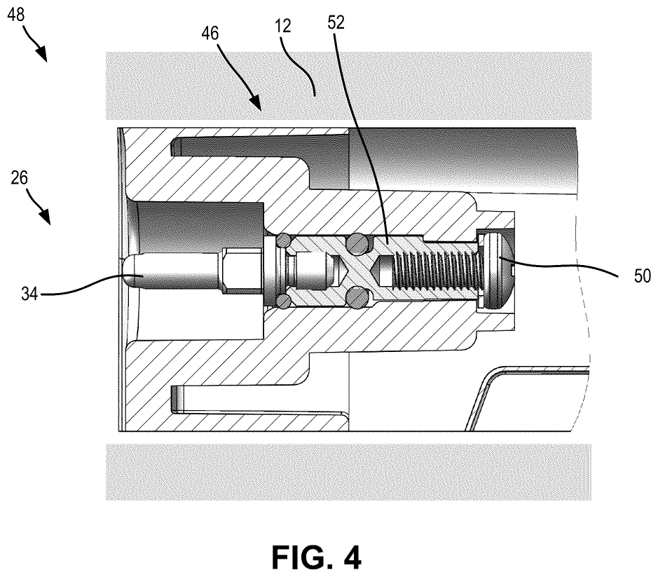

Referring to FIG. 4, in some embodiments, the corrosion-mitigating device 26 may be a coupling system 46 that removably couples the electrical contact 34 to the APC 12 and/or the charging station 22 while allowing for the electrical contact 34 to be externally removed. As used herein, an “externally removable” electrical contact 34 may be accessed from an exterior of the APC 12 and/or the charging station 22 and may be removed from the APC 12 and/or the charging station 22 without requiring access to an interior of the APC 12 and/or the charging station 22. Such coupling systems 46 may allow for removal and/or replacement of electrical contacts 34 as needed to minimize the effects of corrosion on the charging system 10.

FIG. 4 illustrates the electrical contact 34 on the APC 12 and being accessible on an external side 48 of the APC 12. In FIG. 4, the coupling system 46 includes an anchor 50 and a coupling body 52. The anchor 52 may be retained within the APC 12, and the coupling body 52 supports the electrical contact 34 while being attachable to and detachable from the anchor 50. Various engagement mechanisms or systems may be utilized between the coupling body 52 and the anchor 50, such as but not limited to threading, a quarter turn assembly, a barrel assembly, a ratchet assembly, combinations thereof, and/or other mechanisms or systems as desired. In the embodiment illustrated in FIG. 4, the engagement mechanism is threading, and rotation of the coupling body 52 allows for attachment of the coupling body 52 (and thus the electrical contact 34) to the APC 12 and/or detachment of the coupling body 52 from the APC 12.

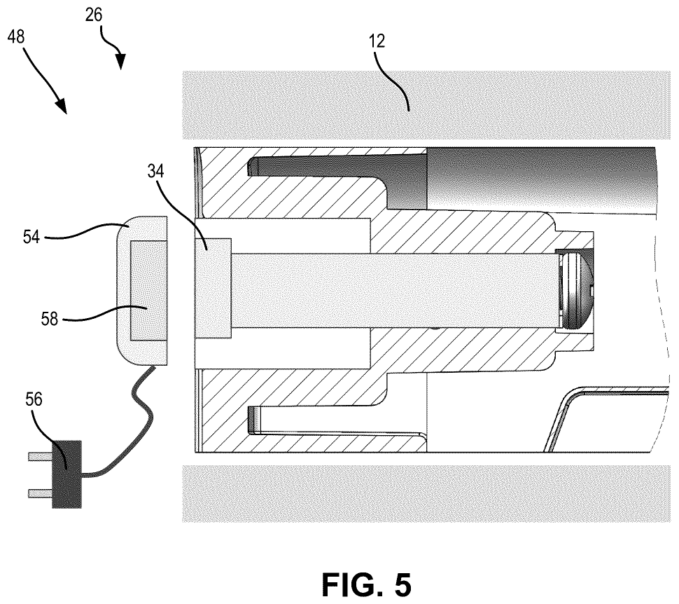

Referring to FIG. 5, in some embodiments, the corrosion-mitigating device 26 may be a cover 54 for the electrical contact 34. In certain embodiments, the cover 54 includes a connector 56 and a surface contact 58. The connector 56 may be coupled to a charging module (e.g., the charging station 22), and during charging, the surface contact 58 may selectively contact the electrical contact 34 while the cover 54 covers the electrical contact 34. In various embodiments, the cover 54 as the corrosion-mitigating device 26 may provide a charge based on contact while facilitating the cleaning of the surface contact 58, connector 56, and electrical contact 34.

The aforementioned corrosion-mitigating devices 26 are for illustrative purposes, and in other embodiments, other types of corrosion-mitigating devices 26 may be utilized as desired for minimizing, reducing, and/or preventing corrosion of the electrical contacts due to the presence of water. Moreover, the various corrosion-mitigating devices 26 described herein may be utilized in various combinations or sub-combinations as desired and on the APC 12 and/or the charging station 22 as desired.

Exemplary concepts or combinations of features of the invention may include:
A. A charging system for an APC, the charging system comprising a corrosion-mitigating device for an electrical contact.
B. The charging system of any preceding or subsequent statement or combination of statements, wherein the corrosion-mitigating device is configured to dry and/or remove water from the electrical contact prior to charging.
C. The charging system of any preceding or subsequent statement or combination of statements, wherein the corrosion-mitigating device comprises a drying device comprising a drying material and/or a hydrophobic material.
D. The charging system of any preceding or subsequent statement or combination of statements, wherein the drying device comprises a fabrics buffer.
E. The charging system of any preceding or subsequent statement or combination of statements, wherein the electrical contact is selectively retractable and extendable through the drying device.
F. The charging system of any preceding or subsequent statement or combination of statements, wherein the drying device is attached to a charger cable for the electrical contact.
G. The charging system of any preceding or subsequent statement or combination of statements, wherein the drying device is movable relative to the electrical contact between a stowed position and a deployed position.
H. The charging system of any preceding or subsequent statement or combination of statements, further comprising a biasing mechanism biasing the drying device toward the stowed position or the deployed position.
I. The charging system of any preceding or subsequent statement or combination of statements, wherein the biasing mechanism comprises a spring.
J. The charging system of any preceding or subsequent statement or combination of statements, wherein the corrosion-mitigating device comprises a cover for the electrical contact, wherein the cover comprises a surface contact configured to contact the electrical contact for charging while the cover covers the electrical contact.
K. The charging system of any preceding or subsequent statement or combination of statements, wherein the cover is at least partially positionable within a cavity for the electrical contact.
L. The charging system of any preceding or subsequent statement or combination of statements, wherein the corrosion-mitigating device is configured to removably couple the electrical contact to an APC or a charging station such that the electrical contact is externally removable from the APC or charging station.
M. The charging system of any preceding or subsequent statement or combination of statements, wherein the corrosion-mitigating device comprises a coupling system such that the electrical contact is externally removable from the APC or a charging station for the APC.
N. The charging system of any preceding or subsequent statement or combination of statements, wherein the coupling system comprises at least one of threading, a quarter turn assembly, a barrel assembly, and/or a ratchet assembly.
O. An APC comprising the charging system of any preceding or subsequent statement or combination of statements, wherein at least the corrosion-mitigating device is on the APC.
P. A charging station comprising the charging system of any preceding or subsequent statement or combination of statements, wherein at least the corrosion-mitigating device is on the charging station.
Q. A charging system for an APC, the charging system comprising a charging pin that is externally removable from the APC or from a charging station for the APC.
R. The charging system of any preceding or subsequent statement or combination of statements, wherein the charging pin comprises a coupling system such that the charging pin is removably coupled to the APC or the charging station.
S. The charging system of any preceding or subsequent statement or combination of statements, wherein the coupling system comprises at least one of threading, a quarter turn assembly, a barrel assembly, and/or a ratchet assembly.
T. An APC comprising the charging system of any preceding or subsequent statement or combination of statements.
U. A charging station comprising the charging system of any preceding or subsequent statement or combination of statements.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A charging system for an automatic pool cleaner, the charging system comprising a corrosion-mitigating device for an electrical contact, wherein the corrosion-mitigating device is configured to dry and/or remove water from the electrical contact prior to charging.

2. The charging system of claim 1, wherein the corrosion-mitigating device comprises a drying device comprising a drying material and/or a hydrophobic material.

3. The charging system of claim 1, wherein the drying device comprises a fabrics buffer.

4. The charging system of claim 1, wherein the electrical contact is selectively retractable and extendable through the drying device.

5. The charging system of claim 1, wherein the drying device is attached to a charger cable for the electrical contact.

6. The charging system of claim 1, wherein the drying device is movable relative to the electrical contact between a stowed position and a deployed position.

7. The charging system of claim 1, further comprising a biasing mechanism biasing the drying device toward the stowed position or the deployed position.

8. The charging system of claim 7, wherein the biasing mechanism comprises a spring.

9. The charging system of claim 1, further comprising a biasing mechanism biasing the drying device toward the stowed position.

10. The charging system of claim 1, wherein the corrosion-mitigating device is configured to removably couple the electrical contact to the automatic pool cleaner or a charging station such that the electrical contact is externally removable from the automatic pool cleaner or charging station.

11. The charging system of claim 1, wherein the corrosion-mitigating device comprises a coupling system such that the electrical contact is externally removable from the APC or a charging station for the automatic pool cleaner.

12. The charging system of claim 11, wherein the coupling system comprises at least one of threading, a quarter turn assembly, a barrel assembly, and/or a ratchet assembly.

13. An automatic pool cleaner comprising the charging system of claim 1, wherein at least the corrosion-mitigating device is on the automatic pool cleaner, wherein the corrosion-mitigating device is configured to dry and/or remove water from the electrical contact prior to charging.

14. A charging station comprising the charging system of claim 1, wherein at least the corrosion-mitigating device is on the charging station.

15. A charging system for an automatic pool cleaner, the charging system comprising a charging pin that is externally removable from the automatic pool cleaner or from a charging station for the automatic pool cleaner, wherein the corrosion-mitigating device is configured to dry and/or remove water from the electrical contact prior to charging.

16. The charging system of claim 15, wherein the charging pin comprises a coupling system such that the charging pin is removably coupled to the automatic pool cleaner or the charging station.

17. The charging system of claim 15, wherein the coupling system comprises at least one of threading, a quarter turn assembly, a barrel assembly, and/or a ratchet assembly.

18. An automatic pool cleaner or a charging station comprising the charging system of claim 15.
